(19) United States
(12) Patent Application Publication
(10) Pub. No.: US 2013/0178080 A1
(43) Pub. Date: Jul. 11, 2013

(54) SOLDERED ELECTRONIC COMPONENTS MOUNTED SOLELY ON THE TOP SURFACE OF A PRINTED CIRCUIT BOARD

(71) Applicant: Kostal of America, Inc., Farmington Hills, MI (US)

(72) Inventor: Holger Lettmann, Novi, MI (US)

(73) Assignee: KOSTAL OF AMERICA, INC., Farmington Hills, MI (US)

(21) Appl. No.: 13/737,538

(22) Filed: Jan. 9, 2013

Related U.S. Application Data
(60) Provisional application No. 61/584,531, filed on Jan. 9, 2012.

(51) Int. Cl. H01R 12/51

(52) U.S. Cl. CPC H01R 12/51
USPC 439/83

(57) ABSTRACT

An electrical connector is securable to a top surface of a printed circuit where other electronic components are mounted. The electrical connector has one or more contact legs that are insertable through apertures in the printed circuit board from the top surface and extending through the bottom surface. A bottom portion of the contact legs may engage with a larger electrical system. The top portion of the contact legs include a shoulder and an anchor pin that mechanically assist in securing the electrical connector to the printed circuit board.

### CROSS-REFERENCE TO RELATED APPLICATIONS

This application claims priority to U.S. provisional patent application 61/584,531, filed Jan. 9, 2012, which is incorporated by reference in its entirety.

### FIELD OF TECHNOLOGY

The present disclosure relates generally to a printed circuit board (PCB), and more particularly to a PCB having surface mounted electronic components on its top surface. Such PCBs may be used in many industrial applications, including without limitation, electronic controls in vehicles such as automobiles.

### BACKGROUND

PCBs are well known for use in packaging electronic components using defined circuit architecture to accomplish a particular function. The PCB may be an insulated carrier plate having an upper and lower surface, with conductive paths formed on at least its top surface. Some known PCBs are disclosed in German Patent No. DE10249575 B3, owned by KOSTAL LEOPOLD GMBH & CO KG. Other more conventional PCBs may have electronic components such as electrical connectors mounted on both of the surfaces of the PCB via soldering with solder material such as lead-containing or lead-free solder paste.

Various techniques are available for mounting and connecting components to the PCB. For example, a component may be secured to the PCB using a mechanical fastener. In another example, a component may be secured to the PCB using a bonding technique, such as, by way of non-limiting example, an adhesive.

There remains a need for a cost effective system and method of manufacturing a PCB having at last one electrical connector and other electronic components mounted to the top surface of the PCB and in electrical communication with a larger electrical system. Such a system may include, without limitation, an automotive electrical system. Electrical communication with an automotive electrical system may be facilitated through an automotive wiring harness attachable to contact legs of the at least one electrical connector(s) pushed through and mounted to the top surface of the PCB.

### SUMMARY

A PCB is provided that has a top surface and bottom surface. An electrical connector is provided that is securable to the top surface of the PCB, along with other electronic components. Other electronic components may include, among others, resistors, transformers, capacitors, etc. The electrical connector has contact legs that are insertable through one or more apertures in the PCB from the top surface through the bottom surface. Such contact legs may ultimately engage with a larger electrical system. Such engagement may occur by any number of methods and systems, including attachment to and communication with an automotive wiring harness.

The disclosed contact legs, at their top ends, include a shoulder and an anchor pin. The anchor pin is oriented similarly to the bottom end of the contact leg and fits through another aperture on the PCB for an improved securement of the electrical connector. The shoulder joins a main body of the contact leg with the anchor pin and is substantially perpendicular to both the bottom end of the contact leg and the anchor pin. The shoulder has at least one surface that contacts the top surface of the PCB. At least one of the surface of the shoulder that contacts the PCB or at least a portion of the anchor pin may also be treated with soldering paste, including lead-free soldering paste, for further mechanical strength in securement. After soldering is complete, the anchor pin, in combination with any soldered surfaces, provides mechanical strength for the securement of the electrical connector to the PCB. Such mechanical strength in the securement may also increase the reliability of the electrical communication involving the electrical connector.

Additionally, if all of the electronic components to be soldered to the PCB are on the top surface of the PCB, than manufacturing processes may be more efficient and less expensive because the soldering manufacturing process occurs once rather than twice. That is, conventional manufacturing processes may involve a soldering process for a top surface followed by a soldering process for a bottom surface, making the entirety of the soldering process twice as long as necessary using the disclosed systems and devices.

Other features and advantages of the present disclosure will become readily appreciated as the same becomes better understood after reading the following description when considered in conjunction with the accompanying drawings.

### BRIEF DESCRIPTION OF THE DRAWINGS

FIG. 1 is a top view of an electrical connector pushed through the top surface of a PCB.

FIG. 2A is a top perspective view of an exemplary PCB.

FIG. 2B is a bottom perspective view of an exemplary PCB.

FIG. 3A is a perspective view of an exemplary electrical connector insertable through apertures in PCBs via the top surface of the PCB.

FIG. 3B is a perspective view of an exemplary electrical connector insertable through apertures in PCBs via the top surface of the PCB.

### DETAILED DESCRIPTION

Referring to the following description and drawings, exemplary approaches to the disclosed systems are detailed. Although the drawings represent some possible approaches, the drawings are not necessarily to scale and certain features may be exaggerated, removed, or partially sectioned to better illustrate and explain the disclosed devices. Further, the description below is not intended to be exhaustive, nor is it to limit the claims to the precise forms and configurations described and/or shown in the drawings.

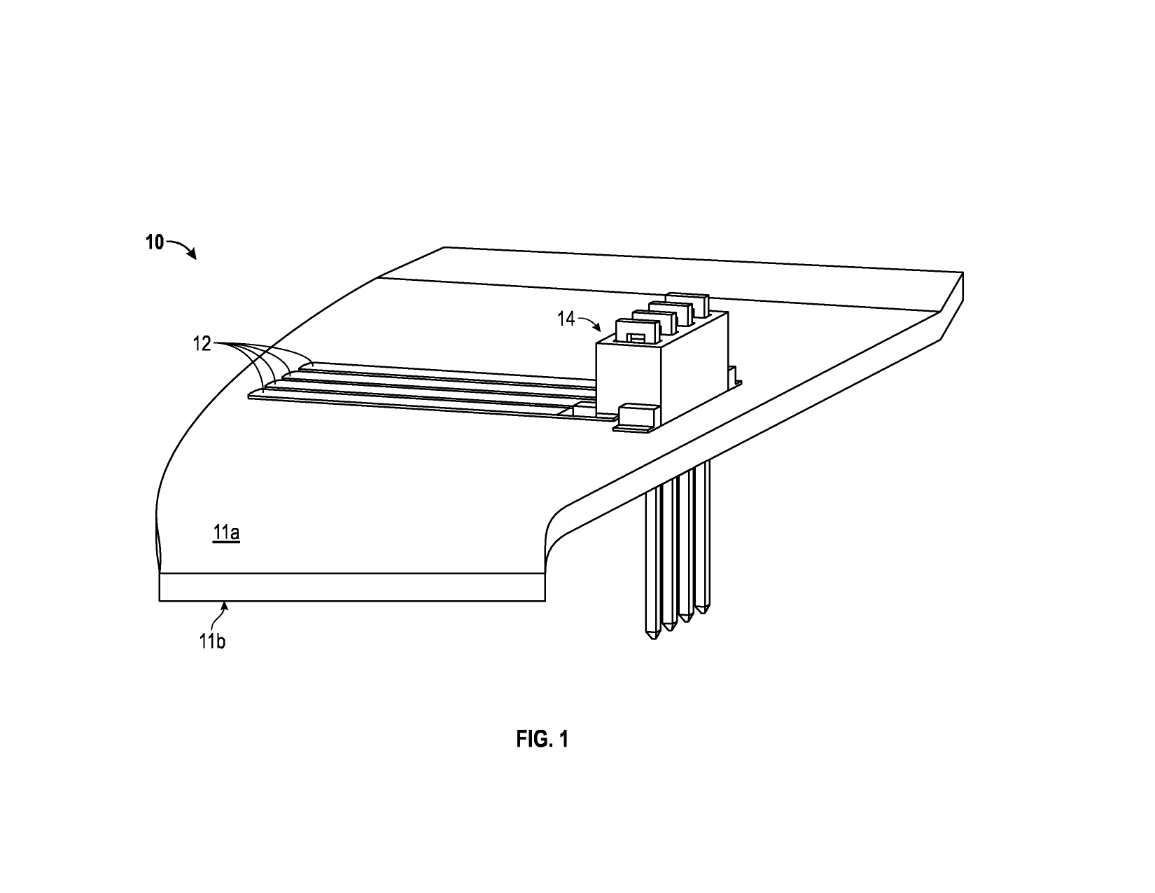

Referring to FIG. 1, an example of a PCB is illustrated. The PCB 10 includes a top surface 11a and an opposed bottom surface 11b. The PCB 10 comprises a substrate that is formed from an insulative material, such as a plastic or phenolic material or the like. The substrate is formed using one layer or multiple layers, as is known in the art. The PCB 10 includes at least one conductive path 12 formed thereon or therein. The conductive path 12, which may be referred to as a trace as depicted in FIG. 1, generally comprises a conductive material, such as copper. The conductive path 12 may be applied in or on the PCB using various techniques, such as a positive or negative resist. The conductive paths 12 may be formed on either or both of the top surface 11a or the bottom surface 11b. Lead solder and lead-free solder may be used to assist in securing electronic components to the PCB 10. In FIG. 1, a weld joint is used to secure the electrical connector 14 onto the PCB 10.

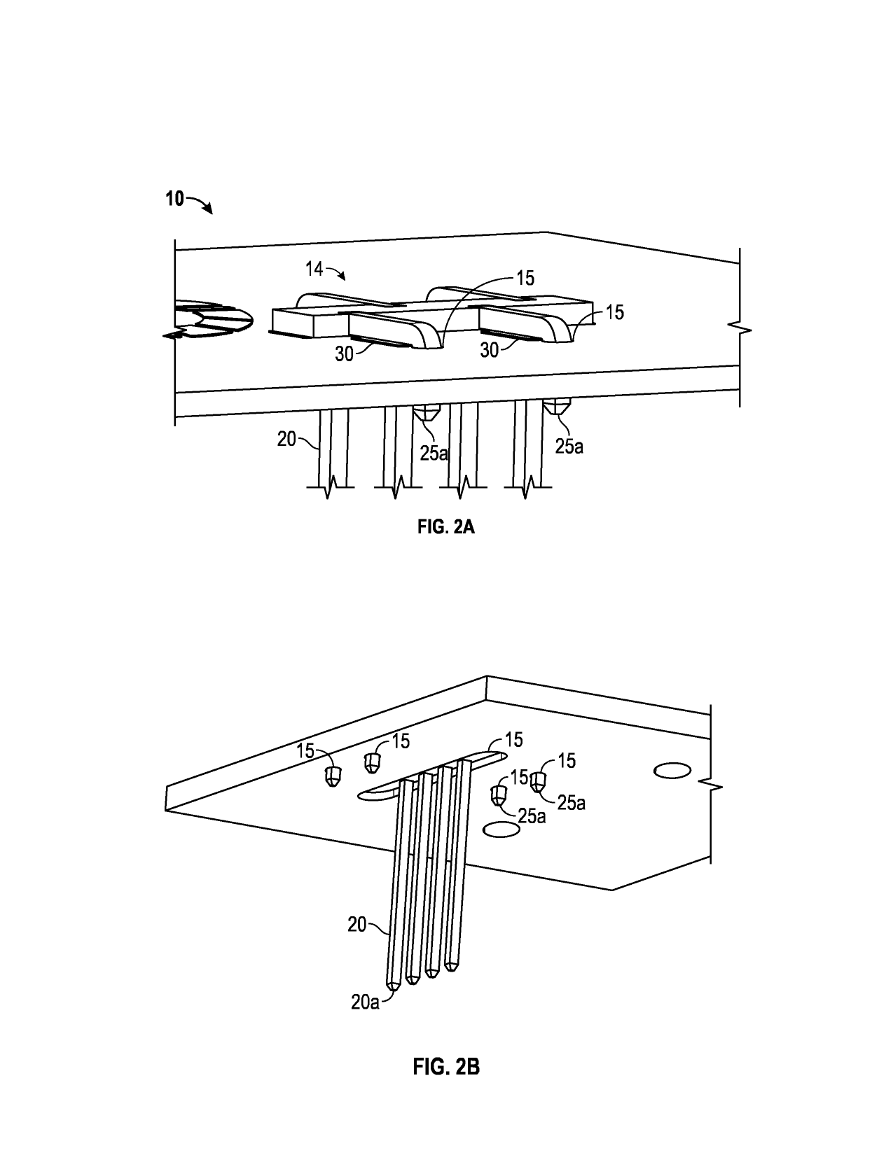

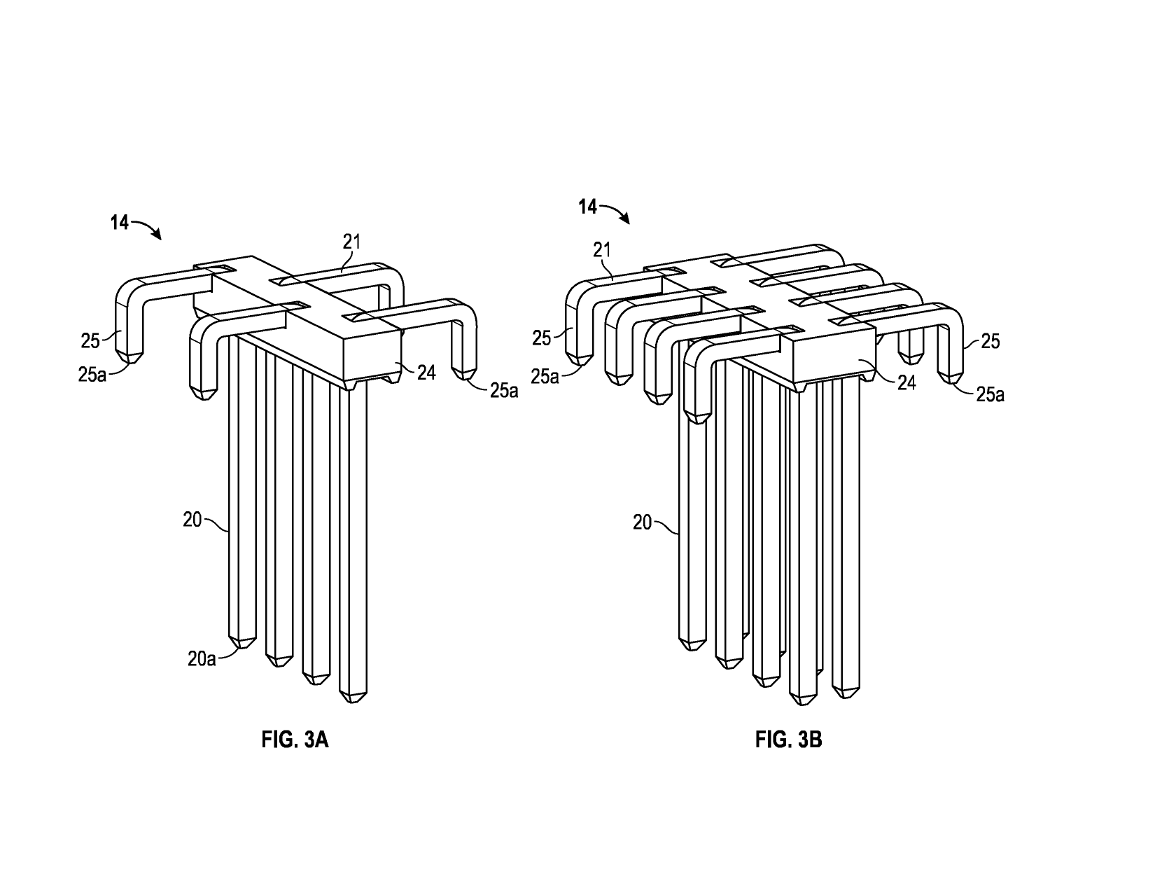

Referring to FIGS. 2A, 2B, 3A and 3B, an exemplary electronic component is illustrated as a mechanically reinforced electrical connector 14 in connection with an associated PCB 10. The electrical connector 14 has at least one contact leg 20. The contact leg 20 has a main body, which after insertion into a PCB 10, has an upper portion that extends from the top surface 11a of PCB 10 and lower portion that extends from the bottom surface 11b of the PCB 10. The contact leg 20, at one end 20a, is adapted to be pushed through an aperture on a PCB 10 and to mechanically engage with and be in electrical communication with an electrical source or larger electrical system. In the automotive context, such engagement may be facilitated through an automotive wiring harness. It should be noted that more surface area of the contact leg 20 than the end 20a is available for mechanical engagement; the end 20a is merely pointed out for ease of explanation, as the end 20a is the entry point of the contact leg 20 through the PCB 10 and ultimately into, for example, an automotive wiring harness. For example, it is contemplated that some or all of the bottom portion 20b of the contact leg 20 may mechanically engage with an automotive wiring harness.

At the top end of the contact leg 20, the contact leg has a shoulder 21 and an anchor pin 25. The anchor pin 25 protrudes from the shoulder 21 and has a lower end 25a. In the depicted example, the shoulder 21 is substantially perpendicular to the contact leg 20 and the downwardly projecting anchor pin 25. The electrical connector 14 may also include a housing 24. The housing 24 may be made of any number of materials, including non-conductive materials. The housing 24 may assist in a manufacturing process by making a series of contact legs 20 easier to manipulate in a collective manner.

Referring to FIGS. 2A and 2B, PCB 10 is provided with a plurality of apertures 15, which vary in shape and size. The apertures may extend entirely through the thickness of the PCB 10. In some examples (not drawn), at least some of the apertures 15 may instead be recesses adapted to receive a portion or all of anchor pins 25. In the depicted example, the ends 20a of contact legs 20 of the electrical connector 14 are insertable into and through the top surface 11a of the PCB 10 through apertures 15. The contact legs 20 extend through the entirety of the PCB 10, and project from the bottom surface 11b of the PCB 10. Similarly, in the depicted example, the lower end 25a of anchor pin 25 is insertable through apertures 15 in PCB 10. In the example, the lower end 25a does not extend as far as the lower end 20a of the contact leg 20, although it does extend entirely through the aperture 15. Other configurations are possible within the scope and meaning of the appended claims.

Referring to FIGS. 2A, 2B, 3A and 3B, the exemplary anchor pins 25 provides assistance with mechanical strength and securement of the electrical connector 14 on the PCB 10, which may improve maintenance of electrical communication between electronic components. Additional securement assistance may be provided by many methods. Some such methods including providing solder paste between at least one of a surface of the shoulder 21 of the contact leg 20 expected to contact the PCB 10 and the anchor pin 25 that contacts an inner surface of the aperture 15 through which it is inserted. It is contemplated that both such structures may be subjected to a soldering process, with lead-containing or lead-free solder material 30.

Many shapes and configurations are contemplated for the contact legs 20. In the illustrated embodiments, the anchor pin 25 together with the shoulder 21 and contact leg 20 have a substantially “J” or “hook” shape. The hook shape, with portions extending through the PCB 10, provides mechanical reinforcement for the securement of the connection or attachment of electrical connector 14 on PCB 10.

When a plurality of electronic components are secured to a PCB 10 at least in part by soldering, there may be advantages to mounting all such electronic components on the top surface of the PCB 10. For example, a PCB 10 may only need to be run through a soldering manufacturing process once, thereby offering possibility of cost savings and efficiency. In such a PCB 10, soldering material would be need only be on the top surface 11a of PCB 10. That is, the soldered mount for electronic components would be solely on the top surface 11a of the PCB 10, even where such electronic components were in electrical communication with other components or pathways on, through or in the bottom surface 11b.

The present disclosure has been described in an illustrative manner. It is to be understood that the terminology which has been used is intended to be in the nature of words of description rather than of limitation. Many modifications and variations of the present example are possible in light of the above teachings. Therefore, within the scope of the appended claims, the present disclosure may be practices other than as specifically described.

What is claimed is:

1. An electrical connector comprising:
a contact leg having a bottom end insertable through an aperture via a top surface of a printed circuit board;
the contact leg having a top end comprising a shoulder and a downwardly projecting anchor pin; and
the anchor pin having a bottom end insertable through an aperture via the top surface of the printed circuit board for mechanical reinforcement of the attachment of electrical connector to the printed circuit board.

2. The electrical connector of claim 1 comprising a plurality of contact legs.

3. The electrical connector of claim 1 wherein the shoulder is substantially perpendicular to the contact leg.

4. The electrical connector of claim 1 wherein the anchor pin is substantially perpendicular to the shoulder.

5. The electrical connector of claim 1 wherein the shoulder is substantially perpendicular to the contact leg.

6. A printed circuit board, comprising:
at least one electrical connector containing a contact leg;
the contact leg having a bottom portion extending through a bottom surface of the printed circuit board;
the contact leg having a top end comprising a shoulder and a downwardly projecting anchor pin; and
the anchor pin having a bottom end extending into an aperture from the top surface of the printed circuit board, thereby providing mechanical reinforcement of the attachment of the electrical connector to the printed circuit board.

7. The printed circuit board of claim 6, wherein the at least one electrical connector is in electrical communication with at least one electronic component mounted on the top surface of the printed circuit board.

8. The printed circuit board of claim 7, wherein the electrical connector and all electronic components are mounted on the top surface of the printed circuit board at least in part with solder material.

9. The printed circuit board of claim 7, wherein the at least one electronic component includes one of a resistor, transformer and capacitor soldered to the top surface of the printed circuit board.

10. The printed circuit board of claim 6 wherein the bottom portion of the contact leg is engageable with an automotive wiring harness.

11. The printed circuit board of claim 6 wherein at least a portion of the anchor pin further comprises solder material.

12. The printed circuit board of claim 6 wherein at least a portion of the shoulder further comprises solder material.

13. The printed circuit board of claim 8 wherein the solder material is lead-free.

14. The printed circuit board of claim 6 wherein the anchor pin extends through the aperture of the printed circuit board such that the bottom end of the anchor pin projects downwardly from the bottom surface of the printed circuit board.

15. The printed circuit board of claim 6 further comprising solder material solely on the top surface of the printed circuit board.
